(19) United States
(12) Patent Application Publication
(10) Pub. No.: US 2017/0362780 A1
(43) Pub. Date: Dec. 21, 2017

(54) Ballast System For Roof Protection

(71) Applicant: Bradford H Cooley, Chattanooga, TN (US)

(72) Inventor: Bradford H Cooley, Chattanooga, TN (US)

(21) Appl. No.: 15/459,638

(22) Filed: Mar. 15, 2017

Related U.S. Application Data
(60) Provisional application No. 62/390,053, filed on Mar. 17, 2016.

(51) Int. Cl. E01C 13/08; E04D 3/32; E04D 11/00; E04D 3/35; A01G 1/00; E04D 3/18

(52) U.S. Cl. CPC E01C 13/08; E04D 11/002; E04D 3/351; E04D 3/32; E04D 3/18; A01G 1/007

(57) ABSTRACT

A tufted geosynthetic lightweight ballast system for roof protection in which the system comprises a composite of one or more geotextiles tufted with one or more synthetic yarns.

### CROSS REFERENCE TO RELATED APPLICATIONS

This non-provisional application is based upon, and claims priority to, U.S. Provisional Patent Application Ser. No. 62/390,053, filed Mar. 17, 2016.

### STATEMENT REGARDING FEDERALLY SPONSORED RESEARCH OR DEVELOPMENT

Not applicable.

### TECHNICAL FIELD

This invention relates to a ballast system for a roof. In a more specific aspect, this invention relates to a tufted geosynthetic lightweight ballast for a protected membrane roof.

In this application, the term “protected membrane roof” will be understood to refer to an inverted roof assembly in which the insulation and ballast are located on top of the membrane. This type of roof is also referred to as an “insulated roof membrane assembly”.

In this application, the term “membrane” will be understood to refer to an impermeable polymeric material, examples of which are polyethylene, high density polyethylene, very low density polyethylene, linear low density polyethylene, polypropylene, polyvinyl chloride, ethylene propylene diene terpolymer, polyurethane, asphalt and bitumen.

In this application, the term “synthetic grass” will be understood to refer to a composite of one or more geotextiles (woven or nonwoven) tufted with one or more synthetic yarns that has the appearance of grass.

In this application, the term “ballast” will be understood to refer to a material that is used to improve stability and/or control, examples of which are stone, gravel, soil, sand and concrete paving slabs (also referred to as concrete pavers).

### BACKGROUND OF THE INVENTION

As known in the art, a protected membrane roof requires a weight of typically 10 to 25 pounds per square foot (psf) of stone ballast in the field interior condition (i.e., the interior area of the roof), and a ballast of 15 to 25 psf of stone ballast around the perimeters and penetrations of the roof. Challenges with conventional stone ballast include wind scour of the stone, heavy weight to put on a roof, difficult to repair and maintain the underlying roof components, cannot easily clean dirt and debris from the roof and unsightly aesthetics. There is the potential for the stone ballast to blow off the roof. If this happens, there are significant risks of property damage and/or personal injury and safety. Building owners and design architects have concern with this potential liability when using a stone ballast for a protected membrane roof.

Concrete pavers are also used as roof ballast, and these pavers have a typical ballast weight of between 15 to 25 psf. Concrete pavers are typically strapped together where they are next to the perimeter of a roof or in areas of potentially high winds. Concrete pavers are expensive, heavy, prone to crack and have unsightly aesthetics. There is a potential for concrete pavers to blow off the roof. If this happens, there are significant risks of property damage and/or personal injury and safety. Building owners and design architects have concern with this potential liability when using concrete pavers for protected membrane roofs.

The purpose of the ballast layer is to protect the underlying membrane and insulation layers of a protected membrane roof from ultraviolet degradation, wind uplift, weather and physical damage/abuse.

Due to the challenges with use of a conventional ballast, there is a need in the industry for a new and improved ballast system for a protected membrane roof.

### SUMMARY OF THE INVENTION

Briefly described, the present invention provides a new and improved ballast system for enhanced protection of a protected membrane roof.

The ballast system of this invention provides a protected membrane roof with enhanced protection from degradation by ultraviolet light, wind uplift, weather and physical damage.

### BRIEF DESCRIPTION OF THE DRAWINGS

FIG. 1 is a schematic view of a prior art protected membrane roof having a typical stone ballast.

FIG. 2 is a schematic view of a prior art protected membrane roof having a typical concrete paver ballast.

FIGS. 3 and 4 are views of a ballast system of this invention showing a tufted geosynthetic lightweight ballast on a protected membrane roof.

FIGS. 5, 6A, 6B and 6C are views of a ballast system of this invention with different configurations.

### DETAILED DESCRIPTION OF THE INVENTION

The present invention provides a tufted geosynthetic lightweight ballast for a protected membrane roof, in which the ballast system comprises a composite of one or more geotextiles tufted with one or more synthetic yarns.

The tufted geosynthetic lightweight ballast is a continuous system that is attached to the edges of the roof. The system can be delivered to the site of the roof in various forms, such as rolls or panels which can be seamed together by various methods, such as sewing, heat welding, adhesive, glue or mechanical means, such as staples, clips, screws or nails. The seaming creates the continuous system.

In the ballast system of this invention, the geotextile functions as a backing for the synthetic yarn to form the composite. The synthetic yarn is tufted to appear as slender elongate elements (also referred to as synthetic vertical filaments, turf grass or vertical filaments). The tufted synthetic yarn may have the appearance of blades of grass, filaments, tufts, follicle-like elements, fibers and narrow cone-sloped elements.

The ballast system of this invention does not require infilling between the synthetic vertical filaments, but infill may be used for additional protection against higher wind velocities and physical damage. If used, the infill between the synthetic vertical filaments can be a granular material, examples of which are sand, coated sand, soil material, pea gravel, gravel, stone, organic materials (such as natural cork and coconut shell fibers), granular or crumb rubber, coated rubber and ethylene propylene diene terpolymer. The synthetic vertical filaments cover and hold the granular material in place. This granular material may or may not be bound. If used, a binding agent is applied to the granular material, and the binding agent may be lime, an organic emulsion, a polymeric emulsion or a cementitious-based material.

In a preferred embodiment, the present invention comprises a tufted geosynthetic lightweight ballast, including synthetic slender elongate elements secured into a backing material. Advantageously, the ballast of this invention does not require piled-on weight to resist wind forces and can be deployed over a large area with little or no additional weight or anchoring.

The tufted geosynthetic lightweight ballast includes slender elongate elements attached to the backing to break the wind aerodynamics on the exposed roof. The testing of this ballast system shows the wind velocity on the surface becomes turbulent near the surface of the roof, thus greatly reducing the actual wind velocity at the tufted geosynthetic lightweight ballast surface and decreasing associated uplift.

The reaction of the slender elongate elements to the wind forces may also create a downward force on the ballast system. This reaction may be caused by the slender elongate elements applying an opposing force against the wind which is transferred as a downward force on the geosynthetic backing. The use of slender elongate elements is a departure from typical roof ballast materials. Examples of slender elongate elements encompassed by the present invention include structures that resemble blades of grass, rods, filaments, tufts, follicle-like elements, fibers and narrow cone-shaped elements.

Advantageously, the tufted geosynthetic lightweight ballast system of this invention can create a larger distance from the material surface to the “free stream” (i.e., when the wind flow is unaffected by the material). The tufted geosynthetic lightweight ballast breaks up the flow stream, increasing the boundary layer (i.e., the distance from surface to the free stream) to the point where uplift forces are very small. This is in contrast to a prior art ballast of stone or pavers, where there is a small distance to the uninterrupted free stream air flow. This small distance in the prior art ballast means there is a large velocity differential over a very short distance, which creates much higher uplift and the need for significant weight or anchoring.

The positive/downward force is a result of a reaction of the slender elongate elements of the lightweight ballast of this invention, with the individual vertical elements acting as springs pushing against the wind. This reaction and opposing force will vary based on the type of cover and the length of the slender elongate elements, which will be shorter or longer depending on the wind design flow for the disruption provided by the ballast system of this invention. Typically, the length of the slender elongate elements will range between about 0.25 and about 4 inches.

The tufted geosynthetic lightweight ballast system of this invention also acts as a protective layer to provide protection to the underlying insulation and membrane layers below from physical damage and weathering. Infill may be added for additional protection. Thus, the ballast system of the present invention can extend the longevity of the roof components over a longer period of time than prior art roof ballast materials.

In a preferred embodiment, this invention uses a geotextile (i.e., as a backing) which is tufted with slender elongate elements. This backing may have one or more geotextile layers and may or may not have a polymeric coating. Preferably, the geotextile is manufactured of polypropylene, but may also be manufactured from polyethylene, nylon, an acrylic polymer or a polyester. The construction of the geotextile with the slender elongate elements may be woven, knitted or non-woven. The polymeric coating provides binding for the slender elongate elements.

The polymeric coating, if used, may be impermeable or perforated. The geotextile backing, with or without the polymeric coating, may be smooth or may have roughened, textured or structural components to increase the friction resistance against the underlying components of the roof system. Preferably, when roughened, the polymeric coating may have an angle of friction which can be higher than 15 degrees. The polymeric coating can be applied by gluing, spraying, coating or extruding a material (such as polyurethane, ethylene propylene diene terpolymer, polypropylene or polyethylene) to the back of the tufted geotextile.

The slender elongate elements also have the added advantage of being fire resistant. Flammability of the tufted geosynthetic lightweight ballast of this invention has been tested and passes the requirements of ASTM D 2859 and meets the standards of the U.S. Consumer Product Safety Commission Standard for Carpets and Rugs.

The slender elongate elements may or may not have infill, which can be loose or bound.

Reflectivity is important for roof structures. Reflectivity lowers the heat in the building as well as reduces the heat island effect. The slender elongate elements provide reflection of ultraviolet radiation. The amount of reflection may be altered by changing the length, shape, size, cross-section and/or color of the slender elongate elements or by including special additives to the synthetic makeup of the elements. In areas where more reflection is needed, the slender elongate elements can be optimized to meet local codes or EnergyStar guidelines.

The reflectivity of a surface depends on the surface's reflectance and emittance, as well as solar radiation. The Solar Reflectance Index (SRI) is used to estimate how hot a surface will get when exposed to full sun. The SRI is calculated from the surface's reflectance and emittance in accordance with ASTM E1980—“Standard Practice for Calculating Solar Reflectance Index of Horizontal and Low-Sloped Opaque Surfaces.” The roof ballast system of this invention has a SRI that ranges between 20 and 100. The SRI depends upon the length, shape, size, cross-section, color and/or material composition of the slender elongate elements.

For a typical reflective roof, reflectivity is difficult to maintain. Dirt, dust and debris cover the reflective surface in a short period of time. For a reflective roof with the ballast system of this invention, dirt, dust and debris will fall between the slender elongate elements and not block their reflective properties.

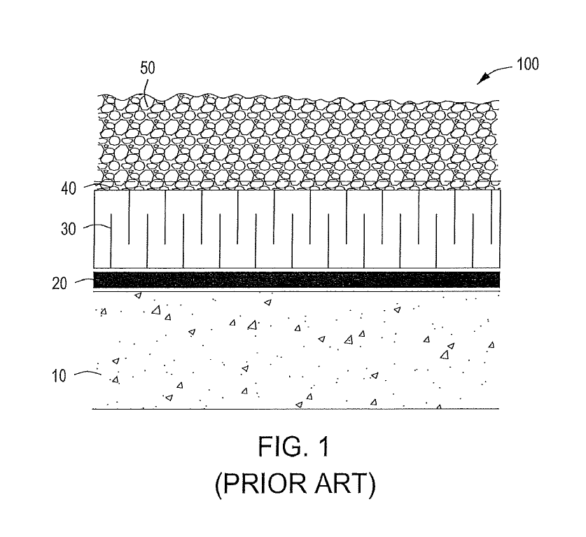

Referring now to the drawings, FIG. 1 shows a prior art system of a cross section of a protected membrane roof 100 with a stone ballast 50. The protected membrane roof sits on the roof deck 10 and is overlain by the membrane 20 which is covered by an insulation layer 30, typically a polystyrene foam insulation. A filter fabric 40 which acts as a separation layer is placed over the insulation layer 30. A layer of stone ballast 50 is placed on top of the entire roof system 100. The weight of this stone ballast 50 is typically 10 to 25 psf in the field interior condition, and 15 to 25 psf around the perimeters and penetrations, depending on the design wind speeds.

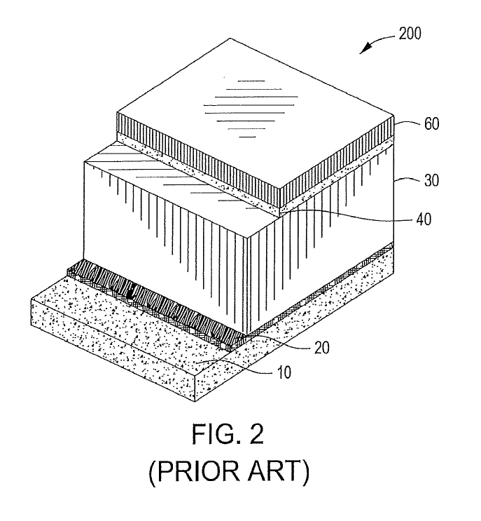

FIG. 2 shows a prior art system of a cross section for a protected membrane roof 200 using concrete pavers 60 as roof ballast. The concrete pavers 60 sit atop the filter fabric 40, insulation layer 30, membrane 20 and roof deck 10. The concrete pavers 60 have a typical ballast weight of between 15 and 25 psf, with the pavers 60 next to the perimeter of the roof being strapped together.

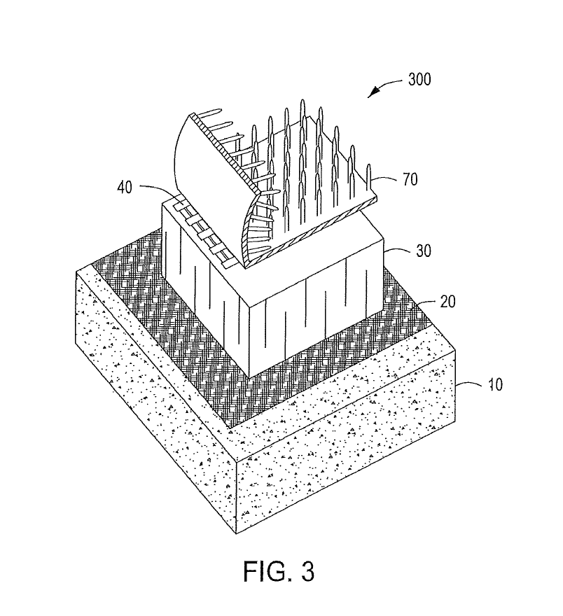

FIG. 3 shows a 3-dimensional view of the ballast system of the present invention, which is a tufted geosynthetic lightweight ballast 70 for a protected membrane roof 300. Other than the ballast layer 70, the roof 300 has the components of a prior art protected membrane roof which include a filter fabric 40, insulation layer 30, membrane 20 and roof deck 10.

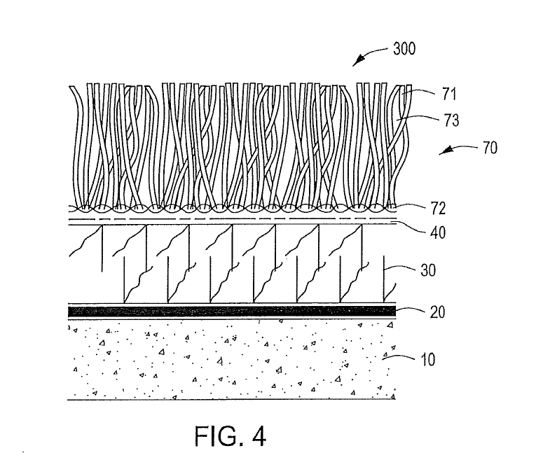

FIG. 4 shows a cross section of an embodiment of the present invention, which is a tufted geosynthetic lightweight ballast 70 for a protected membrane roof 300. The tufted geosynthetic ballast 70 sits upon the roof system 300 of a filter fabric 40, insulation layer 30, membrane 20 and roof deck 10. The tufted geosynthetic ballast 70 is comprised of synthetic strands of slender elongate elements 71 tufted into backing material 72. The tufted geosynthetic is infilled with granular material 73.

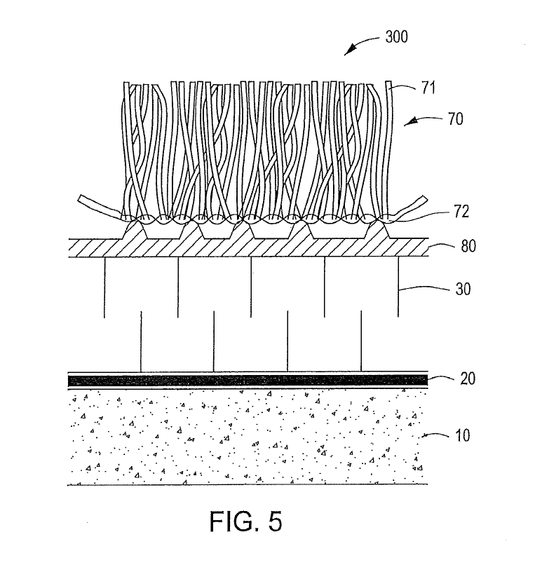

FIG. 5 shows a cross section of another embodiment of the present invention, which is a tufted geosynthetic lightweight ballast 70 for a protected membrane roof 300. The ballast 70 is comprised of synthetic strands of slender elongate elements 71 which are tufted into backing material 72. The ballast 70 is not infilled. This view shows a drainage composite 80 (instead of a filter fabric) under the ballast 70. The function of the drainage composite is to provide drainage as well as diffusion of moisture through the system. This embodiment shows the roof deck 10 under the membrane 20 and insulation layer 30.

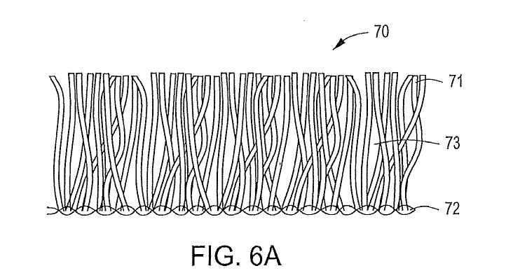

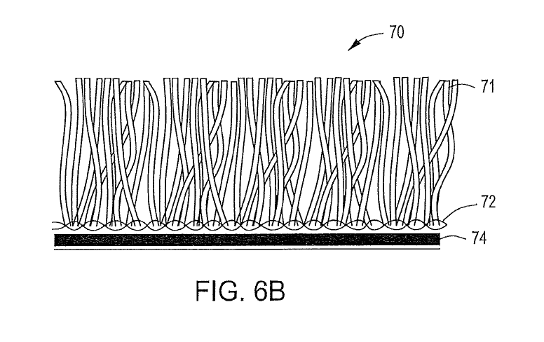

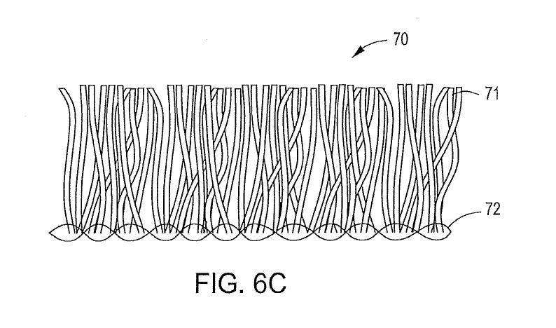

FIG. 6A shows a tufted geosynthetic lightweight ballast 70 of the present invention. The ballast 70 is comprised of synthetic strands of slender elongate elements 71 which are tufted into backing material 72. This ballast system 70 is infilled with a granular material 73.

FIG. 6B shows a tufted geosynthetic lightweight ballast 70 with an impermeable coating 74 on the geotextile backing 72 which is tufted with synthetic strands of slender elongate elements 71. The tufted geosynthetic ballast 70 in this embodiment is not infilled with granular material.

FIG. 6C shows a tufted geosynthetic lightweight ballast 70 with synthetic strands of slender elongate elements 71 tufted into a geotextile backing 72, but without infill.

The present invention allows the use of a protected membrane roof over large areas without heavy ballast or anchorage. The tufted geosynthetic lightweight ballast of this invention can resist wind uplift to protect the components of a protected membrane roof. The ballast system of this invention incorporates slender elongate elements tufted into a geotextile backing, and may or may not be infilled. Infill can be placed between the slender elongate elements. Typically, for the field interior condition of the roof, infill will not be required. For the perimeter areas, infill may be needed. The need for infill will be determined based upon the design wind speeds for the specific application and/or the need for additional protection against physical damage.

The weight of the tufted geosynthetic lightweight ballast of this invention without infill is preferably between about 0.15 to about 2.0 psf, while the weight of the ballast with infill is preferably between about 1.0 to about 15.0 psf. The infill can be loose granular or bound material.

If infill is used as part of the tufted geosynthetic lightweight ballast, the infill will be placed and fall between the slender elongate elements. The infill can be a granular material, examples of which are sand, coated sand, soil material, pea gravel, gravel, stone, organic materials (such as natural cork and coconut shell fibers), granular or crumb rubber, coated rubber and ethylene propylene diene terpolymer. The synthetic slender elongate elements cover and hold the granular material in place. This granular material may or may not be bound. If used, a binding agent is applied to the granular material, and the binding agent may be lime, an organic emulsion, a polymeric emulsion, a cementitious-based material or a pozzolanic-based material.

As used in this application, the term “slender” indicates a length that is greater than its transverse dimension(s). The synthetic slender elongate elements extend upwardly from a backing and form a mat or field to simulate a field of grass, pine straw or similar material.

Preferably, the chemical composition of the synthetic slender elongate elements should be selected to be heat resistant, reflective, flame retardant, resistant to ultraviolet rays (UV) and to withstand exposure to sunlight, which generates heat in the vertical elements and contains ultraviolet rays. Furthermore, the vertical elements should not become brittle when subjected to low temperatures. The synthetic vertical elements should have a color and texture that are aesthetically pleasing and/or reflective.

While other materials can be used for the slender elongate elements, polymeric materials are preferred, such as polyethylene. The vertical elements can be made of high density polyethylene, linear low density polyethylene, polyethylene, polyester, polyvinyl chloride, nylon, polypropylene, or other UV resistant material. While not a requirement of the ballast system of this invention, UV resistance provides an important long term stability for the synthetic slender elongate elements, adding to the overall performance of the ballast system of this invention. For applications where the tufted geosynthetic ballast has the added advantage of reflectivity, the vertical elements may be constructed to be effective by using color, foil or other reflective materials.

Preferably, the synthetic slender elongate elements are tufted to have a density of between about 12 ounces/square yard and about 100 ounces/square yard and, more preferably, a density of between about 20 and about 40 ounces/square yard. The tufting is fairly homogeneous. In general, a “loop” is inserted at a gauge spacing to achieve the desired density. Each loop shows as two vertical elements at each tufted location. Preferably, the synthetic vertical elements have a thickness of at least about 100 microns.

The synthetic slender elongate elements are tufted into the geotextile backing, and preferably compromise one or more polypropylene or polyethylene filaments with UV stabilizers. The vertical filaments can comprise slit film, tape, fibrillated or monofilament fibers. Generally speaking, the lower the surface area of the fiber per unit weight of raw material, the better the UV performance. Monofilament fibers typically have a small cross section relative to their length, which inherently provides for a smaller surface exposed to UV rays per unit weight. A fiber with a round cross-section typically will exhibit better UV resistance than a flat geometric shape.

The geotextile backing can be a single layer, a double layer or can be more than two layers. But preferably, either a single layer or double layer backing is used. The geotextile backing can be made of polypropylene or polyethylene. Also, a separate impermeable coating can be added, such as by applying a membrane-like layer to the back side of the geotextile backing. For example, a urethane coating can be sprayed onto the back of the synthetic geotextile and allowed to cure.

The wind resistant tufted geosynthetic lightweight ballast of this invention was laboratory tested at the Georgia Tech Research Institute (GTRI) Wind Tunnel Lab (Atlanta, Ga.) using wind tunnels to determine the uplift vertical pressures and shear pressures on the system. The wind tunnel trials indicate that the lightweight ballast system of this invention resists the uplift forces of the wind up to at least about 116 miles per hour. The minimal ballast weight of about 0.28 psf for the tufted geosynthetic ballast of this invention is typically all that is required to counteract the shear forces from the wind. For higher winds and at perimeter roof locations, a ballast weight of approximately 4.0 psf may be needed.

The wind-resistant tufted geosynthetic ballast of this invention creates a larger distance from the roof surface to the free stream. The tufted geosynthetic ballast radically breaks up the flow stream, increasing the boundary layer to the point where uplift forces are very small. This is in contrast to prior art exposed ballast systems, in which there is a small distance from the surface (where velocity is 0 feet per second, which is the case for all materials and wind conditions) to the free stream.

The boundary layer conditions are created by longer flow paths over a given surface, and all boundaries grow in thickness and increase in turbulence with increasing distance. In this invention, the interaction of the flow with the flexible slender elongate elements causes the boundary layer growth to occur quite rapidly. As observed in our testing, little to no deflection occurred in the tufted geosynthetic at a distance just over 6 inches from the perimeter edge. The measured uplift results show values requiring minimal uplift resistance that can simply be achieved by the weight of the tufted geosynthetic ballast.

The advantages of the ballast system of this invention include:
Lightweight ballast having significantly less weight than a traditional system to provide equal performance at about 1/30 to about ¼ the weight.
With infill, the system provides additional insulation and protection to the roof.
The slender elongate elements provide solar reflectivity. This reflectivity is maintained because the vertical filaments stand up. Dust and dirt that may accumulate on a roof falls between the filaments, and the filaments maintain their reflectivity. Typical reflective roofs start out performing, but once dust, grime and dirt build up, these roofs are not useful for reflectivity.
Since the ballast system of this invention is lightweight, the roof structure does not have to be built as strong as would be needed to support the traditional ballast materials.
Extremely durable system which adds life to the roof, and protects the underlying membrane from UV, temperatures (thermal shock), weather, the elements and physical damage/abuse.
Being lightweight and durable, the ballast system of this invention offers the ability to have modular garden areas on top of the roof.

This invention has been described with particular reference to certain embodiments, but variations and modifications can be made without departing from the spirit and scope of the invention.

1. A tufted geosynthetic lightweight ballast system for a protected membrane roof, wherein the ballast system comprises a composite of one or more geotextiles tufted with one or more synthetic yarns,
wherein the one or more synthetic yarns are tufted into the one or more geotextiles to produce slender elongate elements having the appearance of grass,
wherein each of the slender elongate elements has a length of about 0.25 to about 4 inches and
wherein the weight of the ballast system without infill is between about 0.15 to about 2.0 pounds per square foot.

2. The ballast system as defined in claim 1 wherein each of the one or more geotextiles comprises a polymeric material.

3. The ballast system as defined in claim 2 wherein the polymeric material is polyethylene, polypropylene, nylon, polyester or an acrylic polymer.

4. The ballast system as defined in claim 1 wherein each of the one or more synthetic yarns comprises a polymeric material.

5. The ballast system as defined in claim 4 wherein the polymeric material is polyethylene, high density polyethylene, linear low density polyethylene, a polyester, polyvinyl chloride, nylon, polypropylene or other UV resistant polymeric material.

6. The ballast system as defined in claim 1 wherein the slender elongate elements are tufted to have a density of between about 12 and about 100 ounces per square yard.

7. The ballast system as defined in claim 1 wherein each of the slender elongate elements have a thickness of at least about 100 microns.

8. The ballast system as defined in claim 1 wherein the one or more geotextiles comprise a single layer or more than one layer.

9. The ballast system as defined in claim 1 wherein each of the slender elongate elements comprise slit film, tape, fibrillated fibers or monofilament fibers.

10. The ballast system as defined in claim 1 wherein infill is used between the slender elongate elements.

11. The ballast system as defined in claim 10 wherein the weight of the ballast system with infill is between about 1.0 and about 15.0 pounds per square foot.

12. The ballast system as defined by claim 10 wherein the infill is sand, coated sand, soil material, gravel, pea gravel, stone, organic materials, granular or cork rubber, coated rubber or ethylene propylene diene terpolymer.

13. The ballast system as defined in claim 1 wherein the system additionally comprises a binding agent.

14. The ballast system as defined by claim 13 wherein the binding agent is lime, an organic emulsion, a polymeric emulsion, a cementitious-based material or a pozzolanic-based material.

15. The ballast system as defined by claim 1 wherein the slender elongate elements are fire resistant.

16. The ballast system as defined by claim 1 wherein the slender elongate elements are reflective.
